(19) United States
(12) Patent Application Publication
(10) Pub. No.: US 2016/0280399 A1
(43) Pub. Date: Sep. 29, 2016

(54) ROCKET ENGINE RECOVERY SYSTEM

(71) Applicants: VLADIMIR VLADIMIROVICH TKACH, KHIMKI (RU); ALEKSANDR EVGENEVICH MILOV, IRKUTSK (RU)

(72) Inventors: VLADIMIR VLADIMIROVICH TKACH, KHIMKI (RU); ALEKSANDR EVGENEVICH MILOV, IRKUTSK (RU)

(21) Appl. No.: 14/398,298

(22) PCT Filed: Nov. 28, 2013
(86) PCT No.: PCT/RU2013/001071

§ 371 Date: Oct. 31, 2014

(30) Foreign Application Priority Data
Nov. 27, 2013 (RU) 2013152622

(51) Int. Cl. B64G 1/62; B64G 1/40

(52) U.S. Cl. CPC B64G 1/62; B64G 1/401

(57) ABSTRACT

This recovery system is used mainly for the recovery of liquid propellant rocket engines, so that they can be reused once or more times, in first stages (one-and-a-half) boosters. The technological goal of this invention is improved reliability of recovery systems. This goal is achieved by the rocket engine recovery system representing of a capsule comprised of a protective bottom and a lateral cover; the capsule includes a parachute bay and a landing gear bay; the capsule is attached to the engine thrust frame; at least one stabilizing parachute; at least one main parachute; at least one landing set of landing gear; the bay with the landing gear is located in the protective bottom of the capsule; the parachute release, the landing gear inflation, and the soft landing engines ignition are initiated, using simplest automatic devices.

APPLICATION AREA

This invention relates to space launch vehicles. It can be used in new designs, or in modernisation of existing single-use space launch vehicles, turning them into systems with reusable components.

The recovery system is used mainly for recovering liquid propellant rocket engines aiming at their second or multiple reuse in the first stage (one-and-a-half) of space launch vehicles.

### EXISTING TECHNOLOGY

There are two main systems for the recovery of components of space launch vehicles, which aim at their multiple reuse.

One of these systems is designed to recover the entire stage of the space launch vehicle, which includes a rocket engine and fuel tanks (RU 2318704 C2, Mar. 10, 2008; U.S. Pat. No. 4,832,288 A, May 23, 1989; U.S. Pat. No. 6,158,693 A, Dec. 12, 2000; U.S. Pat. No. 6,450,452 B1, Sep. 17, 2002; U.S. Pat. No. 6,616,092 B1, Sep. 9, 2003; RU 2492123 C1, Sep. 10, 2013; RU 2442727 C1, Feb. 20, 2012; U.S. Pat. No. 6,817,580 B2, Nov. 16, 2004; RU 2202500 C2, Apr. 20, 2003).

The main disadvantage of these systems is their aiming at the recovery of large and heavy structures. Consequently, these systems are complicated and suggest the use of several auxiliary components: engines for manoeuvring, a wing, fins, a landing gear, fuel for slowing down and controlled descent, parachutes, controls etc. This makes the entire space launch vehicle much heavier and, consequently, reduced considerably the maximum weight of the payload, which raises the cost of launching into the orbit.

Also, heavy recovery systems are complicated, expensive to design and operate, which means that one needs to get more launches to recover the cost. Consequently, the rocket engine used in first stage must have a long service life and work margin. However, designing, tuning up and operating an engine of this kind is very expensive. Massive capital investments, virtually zero economic effectiveness due to the low demand on rocket launching services and stiff competition make the manufacturing of this kind of systems unfeasible. That no systems either type operate at present and that all the space launch vehicles in operation are used only once prove the point.

Only a fundamentally different, a simpler system, designed to recover only the rocket engine can solve the problem of low economical efficiency of recovery systems.

A system of this kind is described in patent U.S. Pat. No. 4,830,314, which describes a liquid-propellant rocket engine mounted inside a spherical capsule. When the engine is in operation during the lift off of the rocket, its propulsion gases exit the capsule through an opening. When the engine is shutdown, the capsule with the engine in it separates from the rocket, special closure doors shut every opening in the capsule, making it air-tight.

This invention aims at recovering rocket engines from almost space altitudes. The capsule descend to the earth at near-space speed, unguided. For this reason, the capsule has thermal shield on the outside, preventing overheating of the engine. Also, the capsule must rotate uncontrollably during its free fall to reduce thermal stresses on its walls. When the free fall becomes slower, it continue to slow decelerate, to acceptable velocities, using parachutes.

This system has the following disadvantages:
having to ensure that the capsule is air-tight; this is achieved with the use of complicated closure door arrangements and sealing components;
using a capsule shell as a primary structure to withstand high aerodynamic stresses;
having a thermal shield;
when a multi-chamber engine is used, the spherical capsule can extend beyond the transverse dimensions of the rocket, causing additional aerodynamic resistance;
the system provides no means for the reduction of shock loads that arise when the capsule comes into contact with the earth;
the capsule rotating during its descent requires that the centre of gravity coincides with the centre of resistance of the entire system, otherwise the system can be destroyed.

This system is closest to the recovery system described in this invention and can be regarded as its closest analogous system.

### DESCRIPTION OF THE INVENTION

The invented rocket engine recovery system is simple. It requires neither air-tightness, nor an excessive strength margin. It contains no mechanisms, nor special control, navigation or manoeuvring devices. It is designed for recovery of rocket engines only;

therefore its weight has been minimised. Consequently, the loss in weight of the payload with respect to single-use space systems is going to be minimal as compared to single-use space launcher systems; therefore the expenses for its manufacturing and operation are going to be minimal too, and the pay-back period is going to be short.

In addition, an engine that has reached the end of its service life, after several reuses, will not require recovery, and the recovery system will not be attached to the rocket on the last voyage of the engine. Consequently, there it will not subtract any weight from the payload, which will cut down the costs of putting it in an orbit.

The short pay-back period of this recovery system means that it will not require building a special long-service-life engine designed specially to fit the recovery system. For this reason, this system can be used with already operating space launch vehicles, requiring only a slight modification to be done to the engine bay. It is possible to manufacture a recovery capsule the size of which not extending beyond the midsection of the rocket.

The new recovery system will also protect the engine from stresses arising during the descent of the capsule in the atmosphere; it will slow down the descent, thanks to atmospheric resistance, absorb the shock on landing on land or water and, in the case of landing on water, ensure the system's buoyancy. The recovery system descends without control. The stabilizing parachute will ensure that the system orients itself in the direction of descent. As the system re-enters the dense layers of the atmosphere, its slowing down to an appropriate velocity will be ensured by the main parachute.

No special thermal shield is required for the new recovery system because its separation from the rocket occurs always at lower altitudes than the orbit and at speeds that are below space velocities, which is—in particular—typical of first stages and one-and-a-half of space boosters. Aerodynamic heating is negligible in these conditions.

The objects of this invention include improved reliability and cost saving in launching a payload due to multiple reuse of the rocket engine.

The objects of this invention are achieved by the rocket engine recovery system containing a capsule made of a protective bottom and a side wall; the capsule consists of a parachute bay, a bay housing landing gear - the said capsule is attached to the engine thrust frame; at least one stabilizing parachute; at least one main parachute; at least one set of landing gear; the said bay with landing gear is located in the protective bottom; parachute deployment, landing gear inflation, and the soft landing motor ignition are carried out with simple automatic devices.

The landing gear represents an inflatable raft or a pneumatic cushion, or soft landing engines.

The parachute bay and the soft landing gear bay are sealed with lids, jettisoned when the respective system is activated.

The gap between the engine nozzle and the open section of the capsule is sealed with a flexible protective cover.

The capsule can accommodate several autonomous rocket engines.

The main parachute is a multi-dome one.

The inflatable raft contains a water-tight membrane, inflatable sections and elastic straps.

The inflatable raft contains an automatic pump-out pump.

The pneumatic cushion contains an exhaust valve.

The system contains a beacon some other detection system.

### BRIEF DESCRIPTION OF THE DRAWINGS

The invention is illustrated with drawings. FIG. 1 shows the recovery system for a single-chamber liquid propellant rocket engine, the means by which the capsule of the recovery system is attached to the rocket, one example of the arrangement of the bays containing auxiliary systems and fuel components supply pipelines;

FIG. 2 depicts an example of the manner in which the engine is mounted to the capsule, the engine thrust is transmitted to the rocket, and stresses transmitted from the parachutes to different structural components;

FIG. 3 shows the landing gear (a raft, or a pneumatic cushion, or soft landing engines) containing bay, and the manner in which the pipelines are arranged and the landing gear packed therein;

FIG. 4 depicts the capsule buoyancy maintenance system for landing on water (at the moment of its activation during the descent), including the inflatable raft, the watertight membrane and straps;

FIG. 5 presents a diagram of the capsule buoyancy maintenance system for landing on water (after it has landed), including the inflatable raft, the watertight membrane and straps;

FIG. 6 shows the pneumatic cushion at the moment when the recovery system lands on a hard surface (at the moment of its activation during the descent);

FIG. 7 shows the pneumatic cushion when the recovery system lands on a hard surface (at the moment of landing, after the landing shock has been absorbed);

FIG. 8 shows a version of the recovery capsule equipped with soft landing engines when the recovery system lands on a hard surface (the lid of the landing bay has been jettisoned);

FIG. 9 shows a diagram of application of the recovery system to recover a liquid propellant rocket engine of first stage of a space booster.

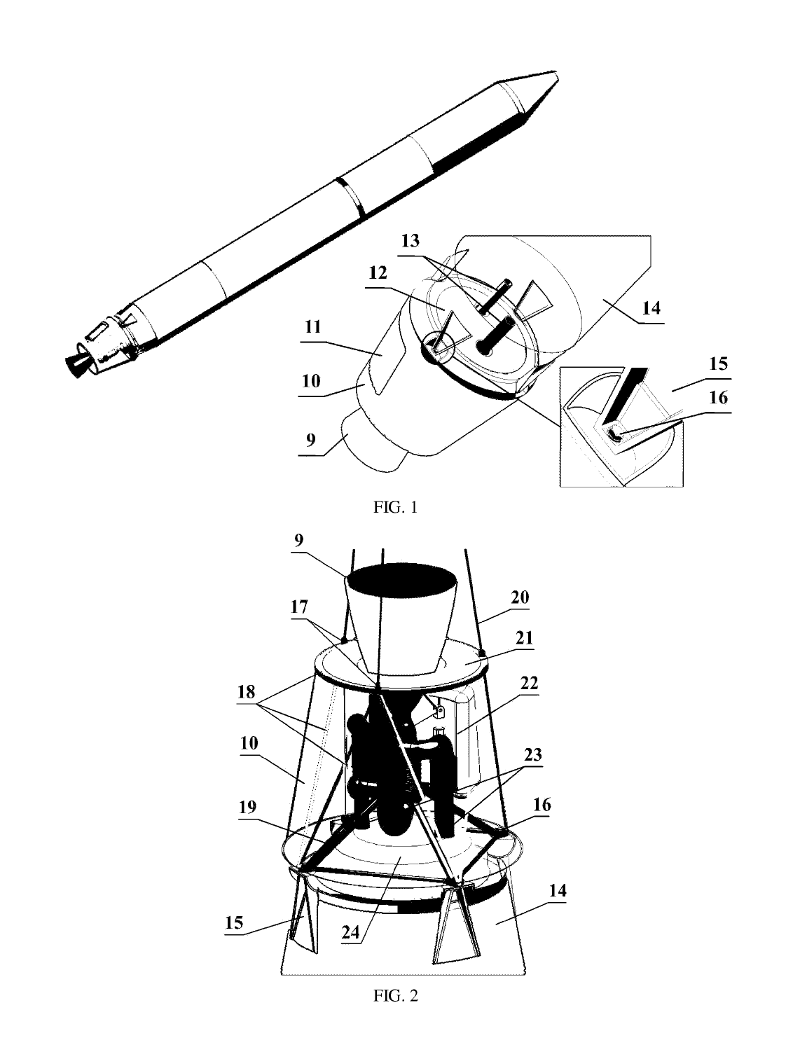

### EXAMPLES OF PRACTICAL APPLICATION

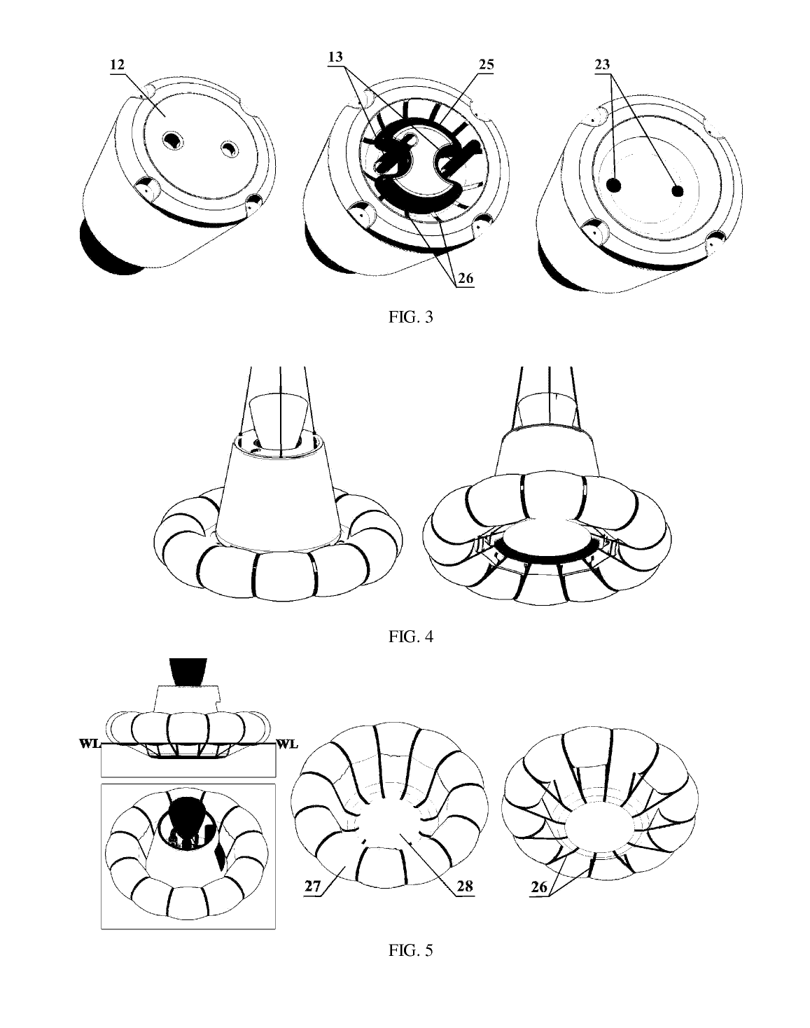

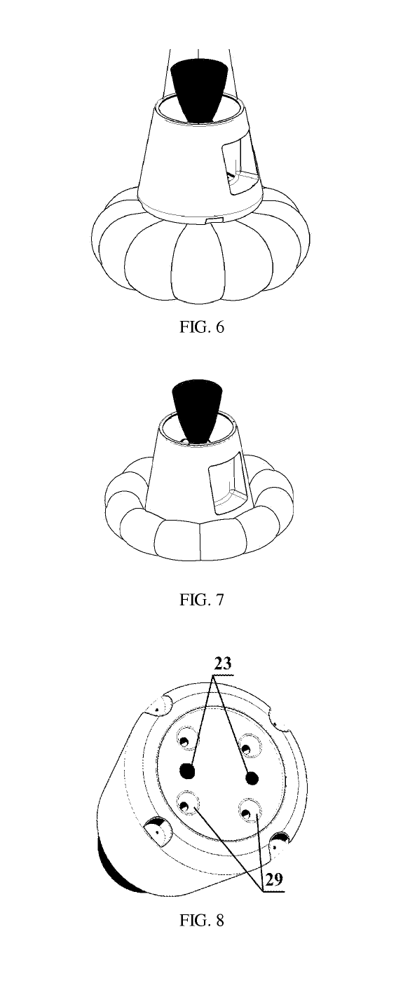

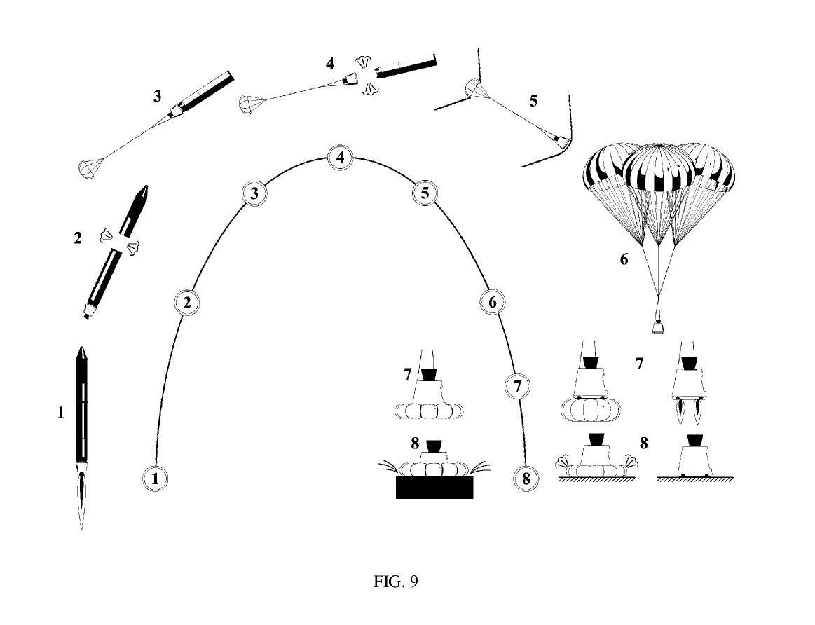

The new recovery system includes a capsule, not air-tight (depicted conventionally as semi-transparent in FIG. 1), which protects the engine 9 from possible damage during its re-entry into the atmosphere or during its landing on a hard surface or on water. The capsule is comprised of the parachute bay 22 and the bay with the landing gear 24, which presents an inflatable raft (FIGS. 4 and 5) for landing on water or a pneumatic cushion (FIGS. 6 and 7). The packaging with the landing gear 25 is shown in FIG. 3. Soft landing engines can be used as landing gear instead of an inflatable cushion for landing on a hard surface. The soft landing engines represent solid-propellant rocket motors: SPRM (FIG. 8).

The capsule itself consists of a bottom, which represents its primary structure. It is the part exposed to greatest aerodynamic stresses during descent and to shock stresses on landing either on water or on a hard surface, and the side wall 10, the purpose of which is to protect the inside of the engine bay of the capsule from direct impact of the environment and from damage and pollution. The capsule is attached to the rocket by means of the mounting bracket 15. The parachute bay 22 can be located either inside or outside the capsule, depending on the arrangement plan. The bay with the landing gear 24 is located in the bottom of the capsule. These bays are closed on the outside with the lid 11 of the parachute bay and with the lid 12 of the landing gear bay respectively. These lids are jettisoned when the corresponding systems is activated. The lid 12 of the landing gear bay also constitutes part of the protective bottom.

The rocket engine 9 (a single- or a multi-chamber) is mounted inside the capsule in a manner that does not restrict its functioning, allowing its gimbaling, pulling its extendable nozzle out or in (if a extendable nozzle is provided for), and its carrying out all the operations required of the engine. The engine nozzle 9 can extend outside the capsule. To prevent combustion products of the engine 9 polluting the inside of the capsule, the gap between the engine nozzle 9 and the open portion of the capsule is covered with the flexible protective cover 21. The capsule is attached to the engine thrust frame 19; it plays no role in transmitting thrust to the rocket.

The side wall 10 of the capsule has a simplest technological geometry (either cylindrical or conical) and the lowest structural weight (since the component is not under the load).

One or several autonomously operating rocket engines can be housed inside the capsule. Their number and sizes define the size of the capsule of the recovery system.

The engine 9 inside the recovery capsule is attached to the rocket at the side of the protective bottom. The connections of the engine 9 with the rocket via primary structure, connection of the fuel supply pipeline 13 from the tanks of the rocket to the engine 9 as well as other connections are disconnects; they represent explosive bolts 16 or some other means known to experts. The fuel components are supplied to the engine 9 through the pipelines 13 passed through appropriate openings made either in the side wall of the capsule or in the protective bottom 12 of the capsule, via the landing gear 24 bay. In this case, the landing gear is arranged around the pipelines 13. The fuel tank 14 of first stage is shown conventionally semi-transparent in FIG. 1. The fuel supply pipelines 13 are shown conventionally semi-transparent in FIG. 3.

In flight, after the engine 9 has completed all the operations required of it for acceleration of the rocket or after fault, the rocket engine 9 shutdowns, the system of disconnection of engine 9 connections with the rocket is activated, and the stabilizing parachute is deployed. The capsule, with the engine 9 mounted in it, separates from the rocket in an unguided ballistic flight, then continued towards the earth. As the capsule separates from the rocket and during the issuing flight, the capsule, supported by the stabilizing parachute, is oriented in the direction of flight by the strength protective bottom 12, which takes the pressure head. This prevents any negative impact that the surrounding atmosphere could exert on the unloaded (peripheral) part of the capsule and open components of the rocket engine 9 (its thrust nozzle). The parachutes are attached with parachute ropes 20 to the mounts of the parachute ropes 17. Also, the stabilizing parachute participates in slowing down the fall of the system, thus reducing aerodynamic stresses on the capsule walls. The braking force is transmitted from the stabilizing and main parachutes directly to the 19 engine thrust frame via primary structure components of the parachute suspension 18.

FIG. 9 depicts a diagram of the recovery of a liquid propellant rocket engine of first stage of a booster. The lift off of the booster is designated 1; the separation of first stage is designated 2; 3 deployment of the stabilizing parachute is designated 3; the separation of the fuel tank of first stage is denoted 4; descent with the stabilizing parachute is denoted 5; the deployment of the main parachute and descent with that parachute are denoted 6; the release of the landing gear (a raft for landing on the water, or a pneumatic cushion, or the soft landing engines ignition) is designated 7; landing is represented by 8.

Air-tightness of the fuel pipelines 13 and engine 9 after their separation from the pipelines of the rocket is insured by the shut-off valves 23, routinely included in rocket engine designs. There is no need to close the openings through which the engine 9 is connected with the rocket because the speed at which the capsule descends is not as high as space velocities. Consequently, thermal stresses generated by the forces of friction between the capsule and the earth's atmosphere are negligible and will cause no structural damage.

The main parachute is used to slow the descent of the capsule down to its landing velocity in the earth's atmosphere. The main parachute is deployed, using a pilot parachute, and the stabilizing parachute can fulfill this role. A multi-dome system can be used to improve reliability and reduce the weight of the main parachute.

As the capsule is not air-tight, when it lands on water, its buoyancy and stable position on water (its WL) with the open part of the engine (its thrust nozzle) up, are ensured using an inflatable raft for landing on (FIGS. 4 and 5). To make stability on water even more secure, the raft is suspended with a strop from the recovery capsule, which permits its partial immersion in water; however, the raft has a bigger radial size than the capsule.

The structure of the raft can include the water-tight membrane 28, which partly protects the submerged part of the capsule from water leaking in. Due to water spray caused by the landing capsule, some water might get in to the inner surface of the membrane. When this happens, the water can be get rid of quickly (before the transportation team arrives) if the raft is equipped with an automatic pumping out pump. Reserve buoyancy of the raft is designed to ensure buoyancy even when one or more inflatable sections 27 are damaged, and even when the entire capsule has been filled with water.

Immediately prior to touching the water, the raft, housed in the landing gear bay 24 of the capsule, inflates and jettisons the lid 12. The design of the raft suspension with strops 26 of appropriate lengths reduces the shock of water-landing because most of the shock is absorbed by the protective bottom 12 of the capsule. The bottom has a smaller surface area than the raft (the force of collision with water decreases proportionally to the surface area of a falling body).

When the landing is on the earth's hard surface, the shock of landing is absorbed by the pneumatic cushion or soft landing engines 29 (FIG. 8). The pneumatic cushion is equipped by exhaust valves, which ensure that its volume decreases gradually during the shock, and consequently, softening the braking when the system touches the surface of the earth. Soft landing engines are activated shortly before the system touches the surface, reducing the free fall velocity.

After the landing on land or water, the capsule with the engine 9 is transported by sea, air or land. The capsule is equipped with a beacon or some other detection system presently used to facilitate detection of the capsule.

The tools used for separating the recovery capsule from the rocket are controlled by the on-board rocket control system. Such functions of the recovery capsule as deploying the parachutes, activating the soft landing engines, inflating the pneumatic cushion or the raft etc. are activated by signals transmitted by simplest automatic devices, such as a timer or a barometric sensor.

### APPLICABILITY IN INDUSTRY

This invention can find application in design of new or modernization of already available single-use space launcher vehicles, by turning the latter ones into systems with some multi-use features. The recovery system is mainly used for recovering liquid propellant rocket engines, aiming at their multiple use in first stages (one-and-a-half) of rockets.

1. A recovery system for rocket engines, comprising:
a capsule constructed of a protective bottom and a side wall;
wherein the capsule contains a parachute bay and a landing gear bay;
wherein the capsule is attached to an engine thrust frame;
at least one stabilizing parachute;
at least one main parachute;
at least one set of landing gear;
wherein the landing gear bay is located in the protective bottom of the capsule;
wherein parachute deployment, landing device inflation and soft landing engines are activated with the use of an automatic device.

2. The system according to claim 1, wherein the landing gear is selected from the group consisting of an inflatable raft, a pneumatic cushion, soft landing engines and combinations thereof.

3. The system according to claim 1, wherein the parachute bay and the landing gear bay are closed with lids, which are jettisoned when a corresponding system is activated.

4. The system according to claim 1, wherein a gap between an engine nozzle and an open portion of the capsule is sealed with a flexible protective cover.

5. The system according to claim 1, wherein the capsule houses several autonomous rocket engines.

6. The system according to claim 1, wherein the main parachute includes more than one dome.

7. The system according to claim 2, wherein the inflatable raft includes a water-tight membrane, inflatable portions and elastic strops.

8. The system according to claim 2, wherein the inflatable raft includes with a pump-out pump.

9. The system according to claim 2, wherein the pneumatic cushion includes exhaust valves.

10. The system according to claim 1, further comprising a beacon or other detection system.
